(19) United States
(12) Patent Application Publication
(10) Pub. No.: US 2026/0218573 A1
(43) Pub. Date: Jul. 30, 2026

(54) IDENTIFICATION AND/OR TRACKING INSERT FOR DRILLING CONSUMABLES AND SYSTEMS AND APPARATUSES COMPRISING SAME

(71) Applicant: BOART LONGYEAR MANUFACTURING AND DISTRIBUTION INC., Salt Lake City, UT (US)

(72) Inventors: Christopher L. Drenth, Callander (CA); Tushar Matkar, Callander (CA); Karl Ingmarsson, Salt Lake City, UT (US); Jeff Hogan, Brampton (CA)

(21) Appl. No.: 19/146,395

(22) PCT Filed: Jan. 12, 2024
(86) PCT No.: PCT/US2024/011387

§ 371 Date: Jul. 8, 2025

Related U.S. Application Data
(60) Provisional application No. 63/479,591, filed on Jan. 12, 2023.

(51) Int. Cl. E21B 17/00; E21B 17/042; G06K 19/06

(52) U.S. Cl. CPC E21B 17/006; G06K 19/06009; E21B 17/042

(57) ABSTRACT

A drill string component can have a first end and an opposed second end that are spaced along a longitudinal axis is disclosed. The drill string component can define a female receptacle that extends inwardly from the first end. The female receptacle can be configured to receive a male connector of a second drill string component. The female receptacle can comprise a shoulder that is axially spaced from the first end of the drill string component. The female receptacle can further comprise an inner circumferential surface defining at least one female thread and an undercut between the at least one female thread and the shoulder. An identification insert can be disposed within the undercut.

### CROSS-REFERENCE TO RELATED APPLICATION

This application claims priority to and the benefit of the filing date of U.S. Provisional Patent Application No. 63/479,591, filed Jan. 12, 2023, the entirety of which is hereby incorporated by reference herein.

### FIELD

The present disclosure relates to drilling consumables and, in particular, to drilling consumables that include identification inserts for tracking the use of the corresponding drilling consumables.

### BACKGROUND

Drilling consumables, such as, for example, percussive drill bits, drill rods, drill rod couplings, and shank adapters (e.g., an adapter between a percussive top-hammer drill and a percussive drill string), are subject to wear and fatigue that exhaust their usable life. Failure (e.g., shearing) of a single drill string component can have disastrous consequences, requiring slow and costly remedies. Accordingly, the drill string consumables are removed from operation prior to exhaustion of their usable life. However, use of each individual consumable is typically not tracked, so batches of consumables are typically removed from operation, regardless of their proximity to their usable life. In this way, many consumables are prematurely removed from operation, thereby leading to financial waste. In further circumstances, it can be desirable to track wear or fatigue in order to analyze performance of individual components (e.g., determine usable life) or plan or analyze frequency of bit sharpening. Accordingly, a way of tracking individual consumables is desirable.

Still further, drilling consumables can be a relatively expensive inventory. It is therefore valuable to track allocation of such resources (e.g., within a particular company or within a particular mine).

### SUMMARY

Described herein, in various aspects, is a drill string component having a first end and an opposed second end that are spaced along a longitudinal axis. The drill string component can define a female receptacle that extends inwardly from the first end. The female receptacle can be configured to receive a male connector of a second drill string component. The female receptacle can comprise an inner circumferential surface defining at least one female thread and an undercut between the at least one female thread and the second end of the drill string component. An identification insert can be disposed within the undercut.

A system can comprise a first drill string component having a first end. The first drill string component can define a female receptacle having a depth from the first end of the drill string component to an innermost end of the receptacle. The female receptacle can comprise at least one female thread extending inwardly into the receptacle from the first end. A second drill string component can define a male connector. The first drill string component and second drill string component can cooperate to define an annular volume therebetween. The annular volume can extend between the at least one thread and the inner end of the receptacle.

A system can comprise a first drill string component and a second drill string component, the first and second drill string components defining opposing shoulders that face each other. An identification insert can be positioned between the opposing shoulders of the first and second drill string components.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a sectional perspective view of a drill string component having an annular identification insert disposed therein.

FIG. 2 is another sectional perspective view of a drill string component having the annular identification insert disposed therein from an opposite side as FIG. 1.

FIG. 3 is a perspective view of the annular identification insert of FIG. 1.

FIG. 4 is sectional perspective view of a system comprising an annular identification insert disposed between a first drill string component and a second drill string component.

FIG. 5 is a perspective view of snap ring pliers as disclosed herein.

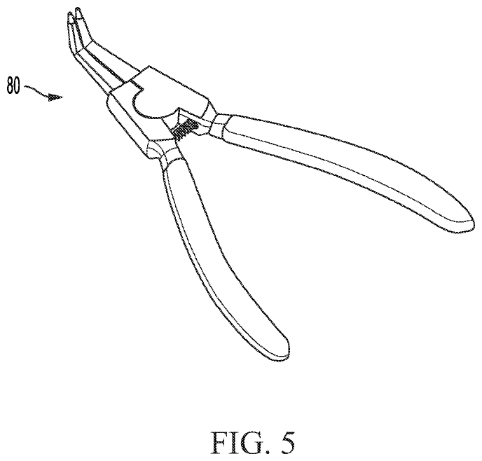

FIG. 6 is a drill string assembly comprising a drill string component having an identification insert according to embodiments disclosed herein.

FIG. 7 is a drill string assembly comprising a drill string component having an identification insert according to embodiments disclosed herein.

FIG. 8 is a drill string assembly comprising a drill string component having an identification insert on an outer circumference according to embodiments disclosed herein.

FIG. 9 is a computing system for tracking drill string components as disclosed herein.

FIG. 10 is a schematic cross section of a drill string assembly having an identification insert in two optional locations.

FIG. 11 is a perspective view of an exemplary borehole camera in use for reading/displaying an alphanumeric identifier disposed on a corresponding annular identification insert, as shown in FIG. 3, disposed within a corresponding percussive drill bit.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “an identifier” can represent disclosure of embodiments in which only a single identifier is provided, and in alternative aspects, can represent disclosure of embodiments in which a plurality of such identifiers are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, if further aspects, when values are approximated by use of “approximately,” “substantially,” and “generally,” it is contemplated that values within up to 15%, up to 10%, up to 5%, or up to 1% (above or below) of the particularly stated value can be included within the scope of those aspects.

The word “or” as used herein means any one member of a particular list and, in additional alternative aspects, can optionally include embodiments in which any combination of members of that list is provided.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without in employing these specific details. Indeed, the apparatus, system, and associated methods can be placed into practice by modifying the illustrated apparatus, system, and associated methods and can be used in conjunction with any other apparatus and techniques conventionally used in the industry.

According to various aspects, the devices, systems, and methods disclosed herein can be used in tracking consumables, such as, for example, drill rods (optionally, percussive drill rods) and percussive drill bits. An identifier can be associated with a consumable. In some aspects, the identifier can be positioned so that the identifier is not subject to wear, or substantial wear, during use of the consumable. The consumable can be, for example, a drill string component.

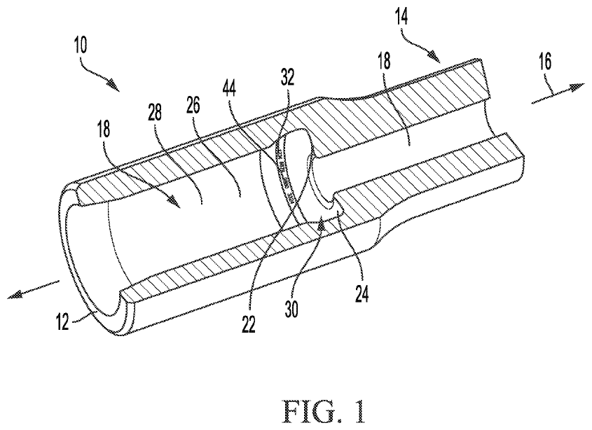

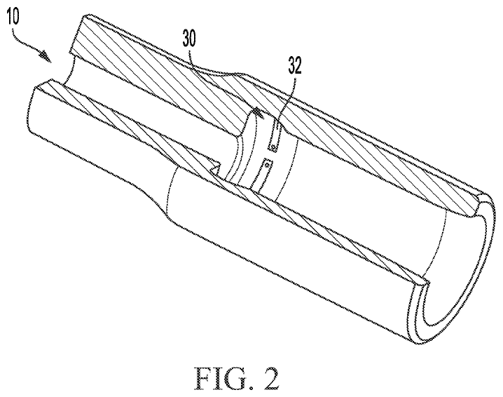

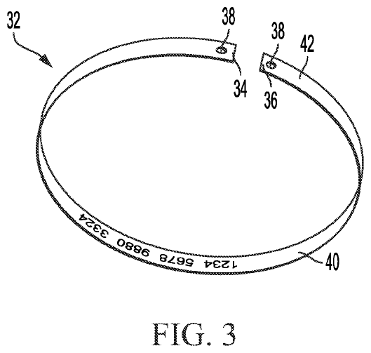

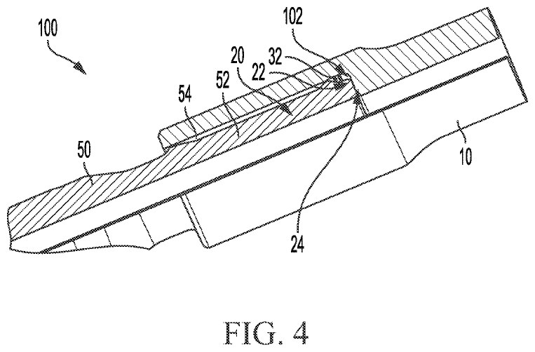

Referring to FIGS. 1-4, a first drill string component 10 can have a first end 12 and an opposed second end 14 that are spaced along a longitudinal axis 16. The drill string component 10 can define a bore 18 therethrough. The first drill string component 10 can define a female receptacle 20 that extends inwardly into the first drill string component 10 from the first end 12 of the drill string component to an innermost end 22 of the receptacle. In some aspects, the receptacle can define a shoulder 24 that is axially spaced from the first end of the drill string component. The shoulder 24 can serve as the innermost end 22 of the receptacle. The receptacle 20 can be configured to receive a male connector 52 of a second drill string component 50. The receptacle 20 can further comprise an inner circumferential surface 26. The inner circumferential surface 26 can define at least one female thread 28 and an undercut 30. In some optional aspects, the undercut 30 can be positioned between the at least one female thread 28 and the shoulder 24. In further aspects, the undercut 30 can be positioned between the at least one female thread 28 and the second end 14 of the first drill string component 10.

An identification insert 32 can be disposed within the undercut 30. In some aspects, the identification insert 32 can be annular. For example, the identification insert 32 can be a split cylinder insert (e.g., a snap ring). Exemplary snap rings include HOOPSTER™ retaining rings manufactured by SMALLEY. The split cylinder insert can be configured to expand to bias radially against the undercut 30 of the inner circumferential surface 26 of the receptacle 20. The identification insert 32 can have a first longitudinal end 34 and a second longitudinal end 36. The identification insert 20 can define a through hole 38 proximate to each end. In this way, in some aspects, the identification insert 32 can be removable from the receptacle 20. For example, inner snap ring pliers 80 (e.g., 90-degree inner snap ring pliers) can be inserted into the holes 38, and the pliers can draw the first and second longitudinal ends 34, 36 together, thereby narrowing an operative diameter of the identification insert 32 so that the identification insert can be removed from the undercut and pulled through the receptacle 20 to the first end 12 of the drill string component 10. It is further contemplated that the identification insert 32 can be non-removably coupled to the drill string component 10 (e.g., via adhesive or other permanent fastening).

In further aspects, the identification insert 32 can be a non-split ring (optionally, of uniform radius). For example, the identification insert 32 can be a continuous ring. The identification insert can be pinched on opposing ends to elastically compress into an oval shape. In this configuration, the identification insert can be inserted into the receptacle 20 past the at least one thread 28 and into the undercut 30 where the identification insert can be released from compression to resiliently return to a ring of uniform (or other pre-compression) radius.

In further aspects, the identification insert 32 can be non-removable from the receptacle 20. For example, the identification insert 32 can be tack welded or adhesively glued, pinned, threadedly fastened, or otherwise mechanically coupled to the first drill string component 10.

The identification insert 32 can be receivable into the undercut 30. For example, in various optional aspects, the identification insert 32 can have a radial thickness of at least 0.010 inches (e.g., at least 0.025 inches, at least 0.05 inches, at least 0.1 inches, at least 0.25 inches, between 0.010 inches and 0.1 inches, or about 0.030 inches). In some aspects, the radial thickness of the identification insert can be limited by the clearance between the undercut 30 and the male end of a mating component (e.g., the male connector 52 of the second drill string component 50). Optionally, the radial thickness of the identification insert can be the depth (in a radial dimension) of the at least one female thread 28. In further aspects, the radial thickness can be equal or substantially equal to the depth of the at least one female thread 28, between ½ of the depth of the at least one female thread and the full depth of the at least one female thread, or between ¼ of the depth of the at least one female thread and the full depth of the at least one female thread. In various optional aspects, the identification insert 32 can have an axial length of about 0.5 inches or less, or about 0.38 inches or less, or about 0.1 inch or less. In some aspects, the identification insert 32 can comprise metal (e.g., steel) or polymer (e.g., silicone or nylon) or combinations thereof. In some aspects, the identification insert 32 can be chemical resistant. For example, in some aspects, the identification insert 32 can be made of a material, or coated with a material, that is resistant to an acid bath that is configured to remove steel from the drill string component. For example, the identification insert 32 can comprise or consist of polyacetal (also known as Polyoxymethylene), or similar material (optionally, similar thermoplastic material), that is resistant to acid baths such as those used on percussive drill bits during bit reconditioning procedures (to expose additional carbide button material, etc.). In some aspects, the identification insert 32 can be formed from an inexpensive material so that it can be disposable. In other aspects, the identification insert 32 can be reusable.

The identification insert 32 can have a thickness so that the identification insert does not interfere with any mating drill string component that is received within the female receptacle 20. For example, in some aspects, the undercut 30 can have a radial depth measured outwardly from proximal portions of the receptacle. In these aspects, the identification insert 32 can optionally have a thickness that is less than or equal to the radial depth of the undercut. In other aspects, the identification insert 32 can be flexible in order to be compressed or otherwise deformed to accommodate the mating drill string component.

In some aspects, the identification insert 32 can comprise an identifier 44. The identifier 44 can be, for example, a visible identifier or an electrically scannable identifier. The identification insert can have an outer surface 40 that is configured to be positioned against the undercut 30 and an opposed inner surface 42. In various optional aspects, the identifier 44 can be on the outer surface 40 of the identification insert 32, the inner surface 42 of the identification insert, or both. The identifier 44 can comprise, or can be, an alphanumeric identifier (e.g., a code or information such as a production date, a date of first use, a production batch number, or a production serialized unit number). In these aspects, the alphanumeric identifier can have at least 4 characters, or exactly 4 characters, or at least 5 characters, or exactly 5 characters, or no more than 10 characters, or no more than 9 characters, or no more than 8 characters, or no more than 7 characters, or no more than 6 characters, or no more than 5 characters. It is contemplated that a lower number of characters can be preferable for having larger characters, whereas a greater number of characters prevents duplication of the identifier. In some aspects, the identifier 44 can be, or can comprise, a color. For example, the identification insert 32 can be a color or have a color pattern that corresponds to a characteristic, such as, for example, a production month, year, etc. of the drill string component.

In further aspects, the identifier 44 can be or comprise a scannable identifier, such as for example, a QR-code, a Data Matrix code, or a barcode. In still further aspects, the scannable identifier can be a radio frequency identifier (RFID). In yet further aspects, the scannable identifier can be a near field communication (NFC) element.

In some aspects, the identifier 44 can be assigned by a user. For example, the identifier 44 can be assigned via RFID writing communication. In other aspects, the identifier can be a hand-marking. In still other aspects, the identifier can be applied by a printer.

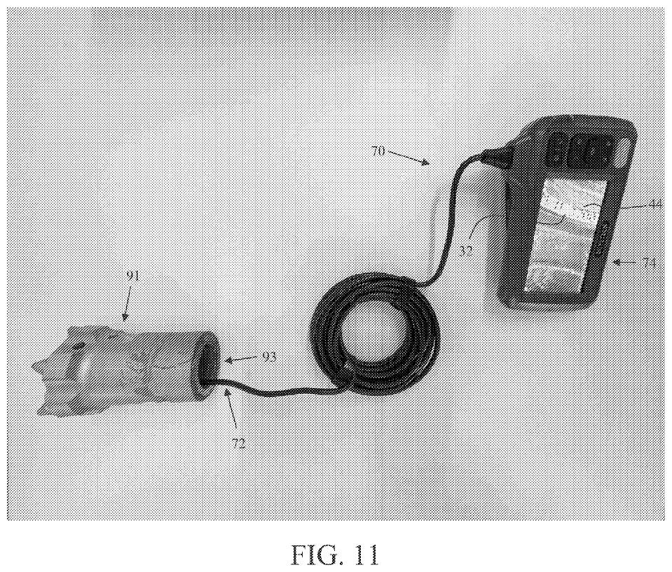

Optionally, the identifier 44 can be read from within the receptacle. For example, a scanner can be inserted into the receptacle, or an operator can look inside the receptacle to see the identifier 44. As shown in FIG. 11, in some exemplary aspects, especially in those instances in which the identification insert 32 comprises an alphanumeric identifier 44, a borehole camera system 70 can be used to read and display the alphanumeric code 44 while the identification insert 32 remains within the receptacle. Specifically, a camera 72 (e.g., an endoscope camera or a borescope camera) of the borehole camera system 70 may be inserted into the bore 93 of the component 91 (depicted as a percussive drill bit in FIG. 11), so that an image including the alphanumeric identifier 44 is displayed to the operator on a remote display panel 74 of the camera system 70. Additionally, or alternatively, it is contemplated that the image can be displayed on a display of a remote computing device as further disclosed herein. Preferably, the camera 72 may include multiple lenses in addition to the axially-aligned lens typically found on basic cameras (e.g., endoscope or borescope cameras). For example, one or more side-view lenses may be provided on the distal end of the camera 72 (e.g., endoscope camera) to facilitate reading the identifier 44 disposed on the identification insert 32. In exemplary aspects, the camera can be a wireless borescope, such as those manufactured by KLEIN TOOLS, or a triple lens endoscope camera, such as those manufactured by DEPSTECH.

In further aspects, the identifier 44 can be read through a wall of the drilling component from outside the component. For example, in some optional aspects, the wall can comprise a window (e.g., a non-metallic window) that permits radio-frequency or other electromagnetic communication therethrough. In further aspects, the identification insert 32 can be an ultrasonic indicator that is capable of transmitting ultrasonic signals through a metallic wall, for example, as disclosed in International Patent Application No. PCT/AU2011/001282 (Publication No. WO2012/045122), filed Oct. 7, 2011, the entirety of which is hereby incorporated by reference herein in its entirety. In yet further aspects, the identification insert 32 can be removed for viewing or scanning the identifier 44.

In some aspects, the identification insert 32 can be inserted into the receptacle 20 after initial use of the first drill string component 10. For example, in some aspects, the identification insert 32 can be inserted into the receptacle 20 when the bit is serviced (e.g., after sharpening, or just before sharpening). In this way, the first drill string component 10 can be associated with a sharpening event or other servicing. In other aspects, the identification insert 32 can be inserted into the receptacle 20 before its initial use (e.g., during initial manufacturing of the drill string component).

A system 100 can comprise the first drill string component 10 and a second drill string component 50. The male connector 52 of the second drill string component 50 can be received into the receptacle 20 of the first drill string component 10. For example, the male connector 52 can define one or more male threads that are complementary to the female thread(s) of the receptacle 20. In some aspects, the male connector 52 can bias against the shoulder 24 of the receptacle 20. The first drill string component 10 and second drill string component 50 can define an annular volume 102 therebetween. The annular volume 102 can extend between the at least one female thread 28 of the receptacle 20 and the innermost end 22 of the receptacle (e.g., along the undercut 30).

The identification insert 32 can be received within the annular volume 102. Optionally, annular volume 32 can be fluidly sealed so that flow through the first and second drill string components does not reach the identification insert.

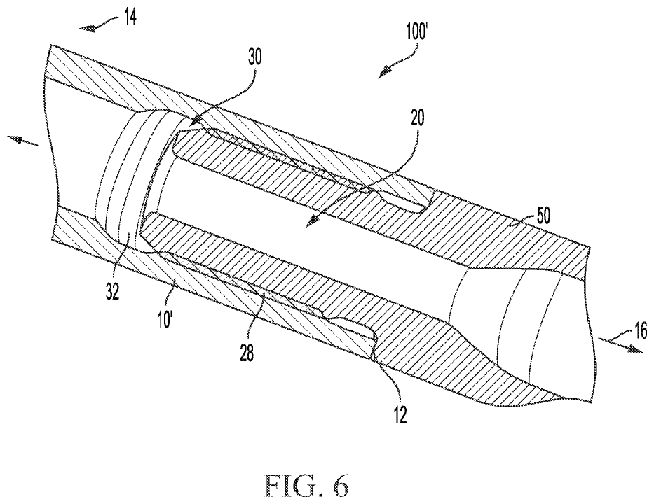

Referring to FIG. 6, in further aspects, a drill string component 10′ can omit a shoulder 24 against which the second (adjacent) drill string component 50 biases. The drill string component 10′ can define a female receptacle 20 that extends inwardly into the drill string component from the first end 12 of the drill string component. The female receptacle can define at least one female thread 28. In some aspects, the drill string component 10′ can define the undercut 30 between the at least one female thread 28 and the second end (e.g., the undercut 30 can be adjacent the at least one female thread 28). The identification insert 32 can be positioned within the undercut.

In some aspects, a system 100′ can comprise a first drill string component 10′ and a second drill string component 50, as shown in FIG. 6. Optionally, the second drill string component 50 can be configured with its own identification insert. The second drill string component can optionally be similar to, or the same as, the first drill string component 10′. The second drill string component can have a male connector 52 that is received into the receptacle 20 of the first drill string component 10′. Optionally, when the second drill string component 50 is coupled to the first drill string component 10′, the identification insert 32 can be spaced from the second drill string component along the longitudinal axis 16. Thus, in some aspects, the identification insert 32 does not interfere with the second drill string component 50, regardless of the radial thickness of the identification insert.

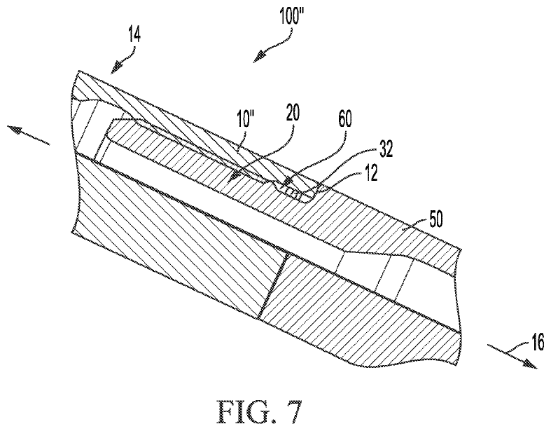

Referring to FIG. 7, in further aspects, a drill string component 10″ can have a first end 12 and an opposed second end 14. The drill string component 10″ can define a female receptacle 20 that extends inwardly into the drill string component from the first end 12 of the drill string component. The female receptacle 20 can define at least one female thread 28. The drill string component 10″ can define an undercut 60 between the at least one female thread 28 of the receptacle 20 and the first end 12 of the drill string component.

In some aspects, a system 100″ can comprise a first drill string component 10″ and a second drill string component 50 as shown in FIG. 7. Optionally, the second drill string component 50 can be configured with its own identification insert. The second drill string component can optionally be similar to, or the same as, the first drill string component 10″. The second drill string component 50 can have a male connector 52 that is received into the receptacle 20 of the first drill string component 10′. In some aspects, the identification insert 32 can be positioned within an annulus defined between the first drill string component 10″ and the second drill string component 50 (e.g., between the first drill string component 10″ and the male connector 52 of the second drill string component 50.

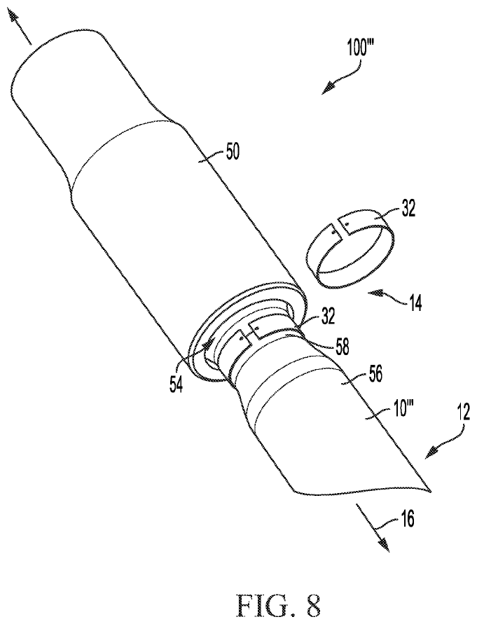

Referring to FIG. 8, in further aspects, the identification insert 32 can be positioned on an outer surface 56 of a drill string component 10′″. For example, the drill string component 10′″ can have a first end 12 and an opposed second end 14 spaced along the longitudinal axis 16. The drill string component 10′″ can define at least one male thread 54 proximate to the second end 14. The outer surface 56 can define an undercut 58 between the at least one male thread 54 and the first end 12. The identification insert 32 can be positioned within the undercut 58 between the at least one male thread 54 and the first end 12. It is contemplated that the undercut 58 can have a sufficient axial length along the longitudinal axis to receive a width of the identification insert 32 (e.g., at least 3 mm, at least 5 mm, at least 10 mm, at least 15 mm, or between 5 mm and 15 mm). The identification insert 32 can comprise a durable, wear-resistant material.

In some aspects, a system 100′″ can comprise a first drill string component 10′″ and a second drill string component 50. Optionally, the second drills string component 50 can be configured with its own identification insert. The second drill string component can optionally be similar to, or the same as, the first drill string component 10′″. The second drill string component 50 can have a female connector that receives the at least one male thread 54 of the first drill string component 10′″. In some optional aspects, the identification insert 32 can be axially spaced from the second drill string component 50.

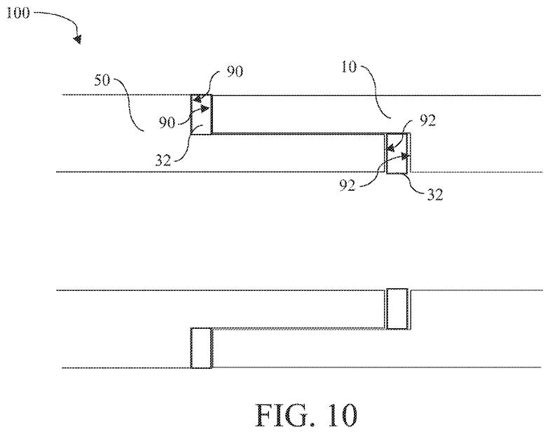

Referring to FIG. 10, a system can comprise a first drill string component 10 and a second drill string component 50. The first and second drill string components 10, 50 can define opposing shoulders that face each other, and an identification insert 52 can be positioned between the opposing shoulders of the first and second drill string components.

In some optional aspects, the tracking insert 32 can be positioned between external mating shoulders 90 of the first drill string component 10 and the second drill string component 50. For example, the identification insert 32 can be positioned on an outer surface of the second drill string component 50 for tracking the second drill string component 50. In other optional aspects, the tracking insert 32 can be positioned between internal mating shoulders 92 of the first drill string component 10 and the second drill string component 50. For example, the identification insert 32 can be positioned on an inner surface of the first drill string component 10 for tracking the second drill string component 50.

In some aspects, the first drill string component 10 and the second drill string component 50 transfer axial force through the identification insert 32. In other aspects, the first and second drill string components 10, 50, when fully coupled together, leave an axial annular space between the mating shoulders so that the identification insert 32 does not transfer axial force between the first drill string component 10 and the second drill string component 50.

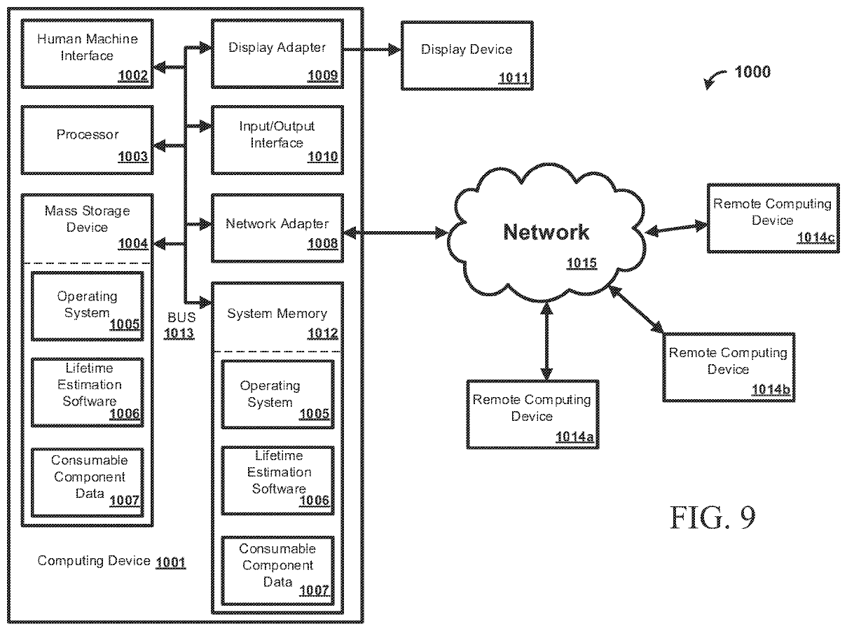

Referring also to FIG. 9, in some aspects, a computing system (e.g., computing system 1000 described further herein) can be configured to track data for various drill string components. For example, a computing device 1001 of the computing system 1000 can receive an identifier 44 from the identification insert 32 of the drill string component 10. In aspects in which the identifier 44 is a visible identifier comprising an alphanumeric code, the computing device can receive a manual input of the alphanumeric code from an operator. For example, as shown in FIG. 11, an operator may read an identifier in the form of an alphanumeric code on an identification insert 32 in the bore 93 of a percussive drill bit 91 by using a borehole camera system 70, and manually input the alphanumeric code with the use of an input/output interface 1010. Optionally, the identifier 44 can be an alphanumeric code that is optically captured and read by a camera and associated computing device in communication with the camera, such as a smartphone device fitted with an auxiliary borehole camera device. In some aspects in which the identifier is an electronically scannable identifier, the identifier can be received by an electronic scanning device (e.g., optionally, an RFID scanner or a near field communication (NFC) scanner). In some aspects, once the identifier is captured (e.g., optically or otherwise electronically scannable), software can associate the captured identifier with other data associated with that identifier (e.g., sharpening dates, hours of use, or any other relevant information).

Receipt of the identifier can be performed, for example via an input device of the computing device 1001 or a separate remote computing device (e.g., remote computing device 1014a). The separate remote computing device 1014a can be a smartphone, tablet, or any suitable device that is configured for communication having an input device (e.g., keyboard, touchscreen, optical scanner, or any other suitable input device) for receiving said identifier. Optionally, a plurality of electronic scanning devices or other remote computing devices (e.g., the remote computing devices 1014a,b,c) can be configured for communication with the computing device 1001. In some aspects, the separate remote computing device can be coupled to an optical device such as a periscope that is receivable into the receptacle 20. The optical device can comprise at least one lens and/or at least one mirror for permitting capture of the identification insert 32 from within the receptacle 20. In this way, a smartphone, tablet, or other computing device comprising a camera can be adapted to capture an optical identifier within the receptacle. In some aspects, the separate remote computing device can be in communication with a camera or other scanner at an end of a probe that is receivable into the receptacle 20.

In some optional aspects, the tool for inserting the identification insert 32 can comprise the scanner. For example, in some aspects, the tool can simultaneously scan the insert (e.g., by optically capturing the identifier or scanning the RFID identifier). For example, the tool can comprise a snap ring tool and a camera and/or RFID scanner.

In some optional aspects, the remote computing device can be in communication with the computing device 1001. In further optional aspects, the remote computing device 1014a can be configured for temporarily storing data for later upload to the computing device 1001.

The computing device 1001 can further receive a usage value associated with the drill string component. For example, after using the drill string component in a drilling operation, an operator can input a duration of use. In some aspects, the computing device can store the duration of use and associate the duration of use with the drill string component. In further aspects, the computing device can determine a remaining life of the drill string component, for example, by subtracting the duration of use from a former remaining life value. Thus, in some aspects, the remaining life can be a time value, such as, for example, a remaining number of hours.

In various aspects, the computing device 1001 can have a memory (e.g., mass storage device 1004) that stores a database. The database can store and associate data from a plurality of drill string components. For example, each drill string component can be associated with a respective identifier the associated data. The associated data can comprise, for example, one or more of: a creation date of the drill string component, a remaining life, a drill log, or a cost value of the drill string component. The drill log can include, for example, each drill site at which the drill string component was used, a duration of use at each drill site, a type of use, and any comments. In further aspects, the computing device can be configured to generate a report on time intervals between scans and compare scan times to the manufacturing date of the drill string component. In some aspects, the computing device can evaluate additional user recorded values (e.g., from using read-write capacity of RFID or NFC). In further aspects, the computing device can be configured to associate drilling location data and drilling data. For example, the computing device can be configured to estimate remaining wear life and/or provide comparisons to similar components or past drilling data. The computing device can provide pre-programmed warnings or recommendations for managing the use or for optimal application, such as the order of the drill string assembly (e.g., recommending more worn or fatigued components toward the proximal end of the drill string (closest to the drill head/rig), and away from the distal-most sections where stress and wear are highest). The computing device can transmit and display reports generated from a cloud database and application.

In various aspects, a drilling system can comprise a drill string having at least one component comprising an identification insert. Each identification insert can be positioned against either an internal surface or an external surface of the component with which it is associated. In some optional aspects, the drill string can be a variable-length drill string. In some optional aspects, the drill string can optionally be a non-flush drill string. In some optional aspects, the drilling system can be a rotary drilling system or a percussive drilling system (e.g., for mining exploration, environmental sampling, or oil exploration). In various optional aspects, the drilling system can be a rotary drill string for water-well drilling, a sonic drill string for geotechnical drilling applications, or any other application in which tracking drill string components is desirable.

In various aspects, embodiments herein can manage wear life and compare consumption to distance drilled. In further aspects, such as, for example, in demanding applications with high load or wear rates, it can be desirable to assemble a drill string with components of relatively less usage and, in particular, with cumulatively less usage than for an application with lower load or lower wear rates. In this way, operators can plan component usage to avoid catastrophic fatigue, failures, fractures, etc. In further aspects, a computing device can comprise software in memory that, when executed by at least one processor, cause the processor(s) to provide a recommended assembly arrangement or a recommended next component to add to the drill string.

In further aspects, drill string components can be managed by a supplier based on drilled distance. The supplier can desire to sharpen bits (e.g., button bits) in order to extend the life. In further aspects, a user can track failure and quality issues to grade the supplier. Optionally, a computing device can receive accumulated data and using software executed by at least one processor, determine, based on the accumulated data, likelihood of failure or quality issues. In yet further aspects, tracking of components can be used to manage drill bit sharpening services. For example, tracking of drill bit use can allow the drill bit supplier to confirm the number of sharpenings of each bit as well as overall sharpenings for a drilling site, a supply contract, etc. Optionally, a computing device can receive accumulated data and using software executed by at least one processor, provide an output correlating sharpenings (e.g., absolute number or frequency) to at least one parameter (e.g., drilling site, supply contract, etc)

In various aspects, the identification insert 32 can allow for usage tracking of the drill string component associated therewith through one or multiple sharpening events. The identification insert 32 can permit tracking while the drill string component associated therewith at a specified job site, or for an entire supply contract, or until retirement of the drill string component.

The statistical usage data, bit sharpening intervals, service intervals, end of service life, number of rods/bits/shanks per meter drilled etc. can be used for efficient management of inventory and with fewer stoppages and breakdowns. Based on this statistical data, operators can determine (optionally, by an analysis and recommendation performed by a computing device) an ideal time to remove components from service to reduce early retirement while not using the component to failure. In this way, productivity can be enhanced to maximize profitability. Such planning can be particularly useful for managing per meter contract.

### Computing Device

FIG. 9 shows a computing system 1000 including an exemplary configuration of a computing device 1001 for use in tracking the drill string component 10. In some aspects, the computing device 1001 can be a portable device that is transported to a drilling site. In further aspects, it is contemplated that a separate computing device, such as, for example, a tablet, smartphone, laptop, scanning device, or desktop computer can communicate with the computing device 1001. Thus, in some aspects, the computing device 1001 can be a server that is remote from the drilling site. In some aspects, what is referred to in this disclosure as the computing device 1001 can be embodied by a plurality of computing devices. For example, a first computing device can be associated with a scanner and can be configured to receive and store drill string component data. A second computing device can receive data from the first computing device for further analysis. Still further, another computing device, such as, for example, a personal computer, workstation, or cloud computing device can interface with the computing device 1001 to enable the user to generate outputs (e.g., charts, graphs, graphics, etc.) based on the data from the system 1000.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as consumable component data 1007 (i.e., location data, drilling data, usage data, etc. as further disclosed herein) and/or program modules such as operating system 1005 and lifetime estimation software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and lifetime estimation software 1006 may be stored on the mass storage device 1004. One or more of the operating system 1005 and lifetime estimation software 1006 (or some combination thereof) may comprise program modules and the lifetime estimation software 1006. The consumable component 1007 may also be stored on the mass storage device 1004. The consumable component 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display device 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A drill string component comprising:
a first end and an opposed second end that are spaced along a longitudinal axis;
a female receptacle that extends inwardly from the first end, wherein the female receptacle is configured to receive a male connector of a second drill string component, wherein the female receptacle comprises:
   an inner circumferential surface defining:
      at least one female thread; and
      an undercut between the at least one female thread and second end of the drill string component; and
   an identification insert disposed within the undercut.

Aspect 2: The drill string component of aspect 1, wherein the identification insert is annular.

Aspect 3: The drill string component of aspect 2, wherein the identification insert is a split cylinder insert that is configured to bias radially against the undercut of the inner circumferential surface.

Aspect 4: The drill string component of aspect 3, wherein the identification insert has a first longitudinal end and a second longitudinal end, wherein the identification insert defines a respective through hole proximate to each of the first and second longitudinal ends of the identification insert.

Aspect 5: The drill string component of any one of the preceding aspects, wherein the at least one female thread has a thread depth, wherein the identification insert has a radial thickness of between ¼ of the thread depth and the thread depth.

Aspect 6: The drill string component of aspect 5, wherein the identification insert has a radial thickness of about the thread depth.

Aspect 7: The drill string component of any one of the preceding aspects, wherein the identification insert has a width along the longitudinal axis of less than 0.5 inches.

Aspect 8: The drill string component of any one of the preceding aspects, wherein the identification insert has a width along the longitudinal axis of about 0.38 inches.

Aspect 9: The drill string component of aspect 8, wherein the identification insert has a width along the longitudinal axis of about 0.1 inches.

Aspect 10: The drill string component of any one of the preceding aspects, wherein the identification insert defines a visible identifier.

Aspect 11: The drill string component of aspect 10, wherein the visible identifier comprises a color.

Aspect 12: The drill string component of aspect 10 or aspect 11, wherein the visible identifier comprises an alphanumeric code.

Aspect 13: The drill string component of any one of the preceding aspects, wherein the identification insert defines an electronically scannable identifier.

Aspect 14: The drill string component of aspect 13, wherein the electronically scannable identifier is scannable via radio frequency.

Aspect 15: The drill string component of aspect 13 or aspect 14, wherein the electronically scannable identifier comprises a barcode, a QR-code, or a Data Matrix code.

Aspect 16: The drill string component of any one of aspects 13-15, wherein the scannable identifier has electronic writing capacity so that the scannable identifier is configured to receive and store information thereon.

Aspect 17: The drill string component of any one of the preceding aspects, wherein the drill string component is a drill rod.

Aspect 18: The drill string component of aspect 16, wherein the drill rod is a percussive drill rod.

Aspect 19: The drill string component of any one of aspects 1-15, wherein the drill string component is a percussive drill bit.

Aspect 20: The drill string component of any one of aspects 1-17, wherein the receptacle comprises a shoulder axially spaced from the first end of the drill string component, wherein the undercut is positioned between the undercut and the at least one female thread.

Aspect 21: The drill string component of any one of Aspects 1-20, wherein the identifier insert comprises polyacetal.

Aspect 22: A drill string component comprising:
a first end and an opposed second end that are spaced along a longitudinal axis;
at least one male thread disposed at the first end;
an undercut between the at least one male thread and the second end; and
an identification insert positioned within the undercut.

Aspect 23: A system comprising:
a first drill string component according to any one of aspects 1-21, wherein the female receptacle has a depth from the first end of the drill string component to an innermost end of the female receptacle, wherein the at least one female thread extends inwardly into the female receptacle from the first end; and
a second drill string component defining a male connector;
wherein the first drill string component and second drill string component cooperate to define an annular volume therebetween, wherein the annular volume extends between the at least one thread and the innermost end of the female receptacle.

Aspect 24: A method of using the drill string component of any one of aspects 1-22, the method comprising:
receiving an identifier from the identification insert of the drill string component;
receiving a usage value associated with the drill string component; and
associating the usage value with the drill string component.

Aspect 25: The method of aspect 24, wherein the identifier is a visible identifier comprising an alphanumeric code, wherein receiving the identifier from the identification insert of the drill string component comprises receiving a manual input of the alphanumeric code.

Aspect 26: The method of aspect 25, wherein receiving the identifier from the identification insert of the drill string component comprises receiving an image of the identifier from a borehole camera system.

Aspect 27: The method of aspect 24, wherein the identifier is an electronically scannable identifier, wherein receiving the identifier from the identification insert of the drill string component comprises receiving the identifier by an electronic scanning device.

Aspect 28: The method of any one of aspects 24-27, wherein associating the usage value with the drill string component comprises calculating, based on the usage value associated with the drill string component, a remaining life of the drill string component.

Aspect 29: The method of any one of aspects 24-28, wherein associating the usage value with the drill string component comprises storing the usage value in association with the identifier of the drill string component.

Aspect 30: The method of any one of aspect 24-29, wherein receiving the usage value comprises receiving the usage value from the identification insert.

Aspect 31: The method of aspect 30, further comprising storing a new usage value on the identification insert.

Aspect 32: The method of any one of aspects 24-29, wherein receiving the usage value comprises receiving an operator input.

Aspect 33: The method of any one of aspects 24-29, wherein receiving the usage value comprises receiving the usage value from a remote computing device.

Aspect 34: A method of using the drill string component of any one of aspects 1-22, the method comprising:
inputting an identifier from the identification insert of the drill string component into a computing device;
using the drill string component in a drilling operation; and
inputting the usage value associated with the drill string component into the computing device.

Aspect 35: The method of aspect 34, wherein the identifier is a visible identifier comprising an alphanumeric code, wherein inputting the identifier from the identification insert of the drill string component comprises inputting a manual input of the alphanumeric code.

Aspect 36: The method of aspect 34, wherein the identifier is an electronically scannable identifier, wherein receiving the identifier from the identification insert of the drill string component comprises scanning the identifier with an electronic scanning device that is configured to communicate with the computing device.

Aspect 37: The method of aspect 36 wherein the electronic scanning device is one of a plurality of scanning devices that are configured to communicate with the computing device.

Aspect 38: The method of any one of aspects 34-37, wherein the drill string component is a first drill string component of a plurality of drill string components, each drill string component of the plurality of drill string components being associated with a respective identifier and at least one respective usage value, wherein the computing device in communication with a memory, wherein the memory has therein a database associating the respective identifiers with at least one respective usage value of each drill string component of the plurality of drill string components.

Aspect 39: The method of aspect 38, wherein the computing device is a first computing device, wherein the first computing device is in communication with a second computing device, wherein the second computing device comprises the memory that stores the database.

Aspect 40: The method of aspect 39, further comprising accessing the database of the second computing device to determine a remaining life of the drill string component.

Aspect 41: The method of aspect 40, wherein the remaining life of the drill string component is a usage duration.

Aspect 42: A system comprising:
a first drill string component; and
a second drill string component, wherein the first and second drill string components define opposing shoulders that face each other; and
an identification insert positioned between the opposing shoulders of the first and second drill string components.

Although the foregoing invention has been described in some detail by way of illustration and example for purposes of clarity of understanding, certain changes and modifications may be practiced within the scope of the appended claims.

1. A drill string component comprising:
a first end and an opposed second end that are spaced along a longitudinal axis;
a female receptacle that extends inwardly from the first end, wherein the female receptacle is configured to receive a male connector of a second drill string component, wherein the female receptacle comprises:
an inner circumferential surface defining:
at least one female thread; and
an undercut between the at least one female thread and second end of the drill string component; and
an identification insert disposed within the undercut.

2. The drill string component of claim 1, wherein the identification insert is annular.

3. The drill string component of claim 2, wherein the identification insert is a split cylinder insert that is configured to bias radially against the undercut of the inner circumferential surface.

4. The drill string component of claim 3, wherein the identification insert has a first longitudinal end and a second longitudinal end, wherein the identification insert defines a respective through hole proximate to each of the first and second longitudinal ends of the identification insert.

5. The drill string component of claim 1, wherein the at least one female thread has a thread depth, wherein the identification insert has a radial thickness of between ¼ of the thread depth and the thread depth.

6. (canceled)

7. The drill string component of claim 1, wherein the identification insert has a width along the longitudinal axis of less than 0.5 inches.

8. (canceled)

9. (canceled)

10. The drill string component of claim 1, wherein the identification insert defines a visible identifier.

11. The drill string component of claim 10, wherein the visible identifier comprises a color.

12. The drill string component of claim 10, wherein the visible identifier comprises an alphanumeric code.

13. The drill string component of any claim 1, wherein the identification insert defines an electronically scannable identifier.

14. The drill string component of claim 13, wherein the electronically scannable identifier is scannable via radio frequency.

15. The drill string component of claim 13, wherein the electronically scannable identifier comprises a barcode, a QR-code, or a Data Matrix code.

16. The drill string component of claim 13, wherein the scannable identifier has electronic writing capacity so that the scannable identifier is configured to receive and store information thereon.

17. The drill string component of claim 1, wherein the drill string component is a drill rod.

18. (canceled)

19. The drill string component of claim 1, wherein the drill string component is a percussive drill bit.

20. The drill string component of claim 1, wherein the receptacle comprises a shoulder axially spaced from the first end of the drill string component, wherein the undercut is positioned between the undercut and the at least one female thread.

21. The drill string component of claim 1, wherein the identification insert comprises polyacetal.

22. (canceled)

23. A system comprising:
a first drill string component according to claim 1, wherein the female receptacle has a depth from the first end of the drill string component to an innermost end of the female receptacle, wherein the at least one female thread extends inwardly into the female receptacle from the first end; and
a second drill string component defining a male connector;
wherein the first drill string component and second drill string component cooperate to define an annular volume therebetween, wherein the annular volume extends between the at least one thread and the innermost end of the female receptacle.

24. A method of using the drill string component of claim 1, the method comprising:
receiving an identifier from the identification insert of the drill string component;
receiving a usage value associated with the drill string component; and
associating the usage value with the drill string component.

25. (canceled)

26. (canceled)

27. (canceled)

28. (canceled)

29. (canceled)

30. (canceled)

31. (canceled)

32. (canceled)

33. (canceled)

34. A method of using the drill string component of claim 1, the method comprising:
inputting an identifier from the identification insert of the drill string component into a computing device;
using the drill string component in a drilling operation; and
inputting the usage value associated with the drill string component into the computing device.

35. (canceled)

36. (canceled)

37. (canceled)

38. (canceled)

39. (canceled)

40. (canceled)

41. (canceled)

42. (canceled)
